(19) United States
(12) Patent Application Publication
(10) Pub. No.: US 2026/0161981 A1
(43) Pub. Date: Jun. 11, 2026

(54) METHOD AND APPARATUS WITH PREDICTIVE MODEL GENERATION BASED ON RELATIONSHIP GRAPH

(71) Applicant: Samsung Electronics Co., Ltd., Suwon-si (KR)

(72) Inventors: Byunggook NA, Suwon-si (KR); Seung Jin KANG, Suwon-si (KR); Gunhee KIM, Suwon-si (KR)

(73) Assignee: Samsung Electronics Co., Ltd., Suwon-si (KR)

(21) Appl. No.: 19/175,885

(22) Filed: Apr. 10, 2025

(30) Foreign Application Priority Data
Dec. 6, 2024 (KR) 10-2024-0180567

(51) Int. Cl. G06N 7/01; G06F 17/11

(52) U.S. Cl. CPC G06N 7/01; G06F 17/11

(57) ABSTRACT

A processor-implemented method including generating a first graph based on at least one probability corresponding to relationships between a plurality of features, iteratively performing, in a plurality of rounds, operations, the operations including generating at least one second graph based on the first graph, the second graph being a directed acyclic graph, generating at least one first multi-feature prediction model based on the at least one second graph, and training the at least one first multi-feature prediction model, and deriving a second multi-feature prediction model from the at least one first multi-feature prediction model, the first graph including nodes corresponding to the plurality of features and at least one edge corresponding to at least a portion of the relationships.

### CROSS-REFERENCE TO RELATED APPLICATIONS

This application claims the benefit under 35 USC § 119 (a) of Korean Patent Application No. 10-2024-0180567 filed on Dec. 6, 2024, in the Korean Intellectual Property Office, the entire disclosure of which is incorporated herein by reference for all purposes.

### BACKGROUND

### 1. Field

The following description relates to a method and apparatus with relationship graph-based multi-feature prediction model generation.

### 2. Description of Related Art

A multi-feature prediction model refers to a model configured to predict multiple properties (or “features” herein) simultaneously based on single input data. This model may simultaneously predict multiple physical or chemical properties (or “features” herein) including, for example, energy, electronic structures, spectral properties, and the like. A typical method of designing separate models to predict respective features has been mainly used, but a model structure using a multi-task learning technique has recently been introduced which may efficiently predict multiple features.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a first graph based on at least one probability corresponding to relationships between a plurality of features, iteratively performing, in a plurality of rounds, operations, the operations including generating at least one second graph based on the first graph, the second graph being a directed acyclic graph, generating at least one first multi-feature prediction model based on the at least one second graph, and training the at least one first multi-feature prediction model, and deriving a second multi-feature prediction model from the at least one first multi-feature prediction model, the first graph including nodes corresponding to the plurality of features and at least one edge corresponding to at least a portion of the relationships.

The generating of the second graph may include deriving, based on a result of the training, one or more second graphs generated in at least one previous round preceding a current round and generating the second graph based on the derived second graphs.

The generating of the second graph may include extracting one or more combinations between the one or more second graphs generated in the previous round, for each of the combinations, generating a merged graph that merges second graphs included in each combination, generating a third graph by randomly deleting or retaining each of all edges included in the merged graph, based on the at least one probability, and extracting the second graph from the third graph, based on whether the third graph is the directed acyclic graph.

The generating of the second graph may include iteratively extracting one of the one or more second graphs generated in the previous round, generating one or more third graphs by transforming the one of the second graphs, and extracting the second graph from the third graphs, based on whether the third graph is the directed acyclic graph.

The third graph may include one or more of a graph acquired by adding at least one edge to the one of the second graphs, a graph acquired by deleting at least one edge included in the one of the second graphs, and a graph acquired by inversing at least one edge included in the one of the second graphs, based on the at least one probability.

The generating of the second graph may include in a current round, acquiring an edge vector by performing an action of an agent corresponding to edges of the first graph based on the at least one probability and extracting the second graph, based on whether a graph based on the edge vector corresponds to the directed acyclic graph, the edge vector may include a vector having a first number of dimensions equal to a second number of the edges included in the first graph.

The agent may have, as a reward, a value based on a performance metric acquired through the training in the current round.

The first multi-feature prediction model may include a plurality of feature prediction processing elements corresponding respectively to the nodes and the generating of the first multi-feature prediction model may include generating the first multi-feature prediction model such that an input value of each of the plurality of feature prediction processing elements is determined based on a structure of the second graph.

The input value of each of the plurality of feature prediction processing elements may be an output value of a feature prediction processing element corresponding to a parent node of a node corresponding to a corresponding feature prediction processing element.

The output value of the feature prediction processing element corresponding to the parent node may be an output value of a last feature vector among feature vectors included in the feature prediction processing element.

The training of the first multi-feature prediction model may include training the first multi-feature prediction model based on a predetermined dataset.

The method may include deriving a performance value of the first multi-feature prediction model, using a predetermined evaluation method associated with a field in which at least one of the plurality of features is used.

The training the at least one first multi-feature prediction model may include performing an evaluation of the at least one first multi-feature prediction model for each round and the deriving a second multi-feature prediction model may include selecting a first multi-feature prediction model from the at least one first multi-feature prediction model with a highest evaluation as the second multi-feature prediction model.

In a general aspect, here is provided an electronic apparatus including processors configured to execute instructions and a memory storing the instructions, and an execution of the instructions configures the processors to generate a first graph based on at least one probability corresponding to relationships between a plurality of features, iteratively perform, in a plurality of rounds, operations which include generating at least one second graph based on the first graph, the second graph being a directed acyclic graph, generating at least one first multi-feature prediction model based on the at least one second graph, and training the at least one first multi-feature prediction model, and derive a second multi-feature prediction model from the at least one first multi-feature prediction model, and the first graph includes nodes corresponding to the plurality of features and at least one edge corresponding to at least a portion of the relationships.

The generating of the second graph may include deriving, based on a result of the training, one or more second graphs generated in at least one previous round preceding a current round and generating the second graph based on the derived second graphs.

The generating of the second graph may include extracting one or more combinations between the one or more second graphs generated in the previous round, for each of the combinations, generating a merged graph that merges the second graphs included in each combination, generating a third graph by randomly deleting or retaining each of all edges included in the merged graph, based on the at least one probability, and extracting the second graph from the third graph, based on whether the second graph is the directed acyclic graph.

The generating of the second graph may include iteratively extracting one of the one or more second graphs generated in the previous round, generating one or more third graphs by transforming the one of the second graphs, and extracting the second graph from the third graphs, based on whether the third graph is the directed acyclic graph.

The generating of the second graph may include, in a current round, acquiring an edge vector by performing an action of an agent corresponding to edges of the first graph based on the at least one probability and extracting the second graph, based on whether a graph based on the edge vector corresponds to the directed acyclic graph, the edge vector may include a vector having a first number of dimensions equal to a second number of the edges included in the first graph.

The first multi-feature prediction model may include a plurality of feature prediction processing elements corresponding respectively to the nodes, the generating of the first multi-feature prediction model may include generating the first multi-feature prediction model such that an input value of each of the plurality of feature prediction processing elements is determined based on a structure of the second graph.

The input value of each of the plurality of feature prediction processing elements may be an output value of a feature prediction processing element corresponding to a parent node of a node corresponding to a corresponding feature prediction processing element.

### BRIEF DESCRIPTION OF THE DRAWINGS

FIG. 1 illustrates an example method of a relationship graph-based multi-feature prediction model generation according to one or more embodiments.

FIG. 2 illustrates an example method of a relationship graph-based multi-feature prediction model generation according to one or more embodiments.

FIGS. 3A and 3B illustrate example methods of generating a first graph according to one or more embodiments.

FIG. 4 illustrates an example method of generating a second graph from a first graph according to one or more embodiments.

FIG. 5A illustrates an example method of generating a second graph according to one or more embodiments.

FIG. 5B illustrates an example method of generating a second graph according to one or more embodiments.

FIG. 6 illustrates an example method of generating a multi-feature prediction model according to one or more embodiments.

FIG. 7 illustrates an example relationship graph-based multi-feature prediction model generation apparatus according to one or more embodiments.

FIG. 8 illustrates an example method of domain evaluation according to one or more embodiments.

FIG. 9 illustrates an example electronic apparatus with relationship graph-based multi-feature prediction model generation according to one or more embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

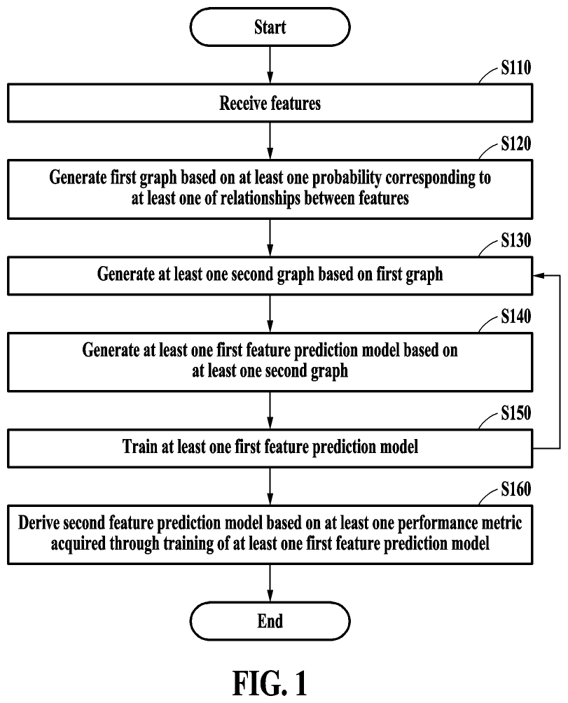

FIG. 1 illustrates an example method of a relationship graph-based multi-feature prediction model generation according to one or more embodiments. In the following example embodiments, operations or steps may be performed sequentially but are not necessarily performed sequentially. For example, the order of the operations or steps may be changed, and at least two of the operations or steps may be performed in parallel.

Referring to FIG. 1, in a non-limiting example, a relationship graph-based multi-feature prediction model generation method (or simply a “generation method” hereinafter), which is a method of generating a relationship graph-based multi-feature prediction model, may provide a multi-feature prediction model through steps S110 to S150.

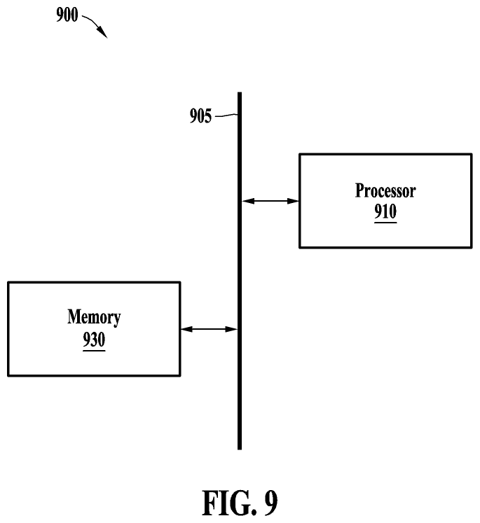

The generation method may be performed by a relationship graph-based multi-feature prediction model generation apparatus (or simply a “generation apparatus” hereinafter) (e.g., electronic device 900 of FIG. 9) including at least one processor (e.g., processor 910 of FIG. 9).

In an example, in step S110, the generation apparatus e.g., electronic device 900 of FIG. 9) may receive, as an input, a plurality of properties (or “features” herein). For example, a user may input, to the generation apparatus, a plurality of features for which the user desires to acquire predicted values. The plurality of features may refer to data that is included in a specific domain (or field). The plurality of features may be defined differently for each domain (or field). For example, in the domain (or field) of materials, the plurality of features may include energy, highest occupied molecular orbital (HOMO), lowest unoccupied molecular orbital (LUMO), spectrum peak, and the like. For another example, in the field of healthcare, the plurality of features may include heart rate, blood pressure, blood glucose level, oxygen saturation, and the like.

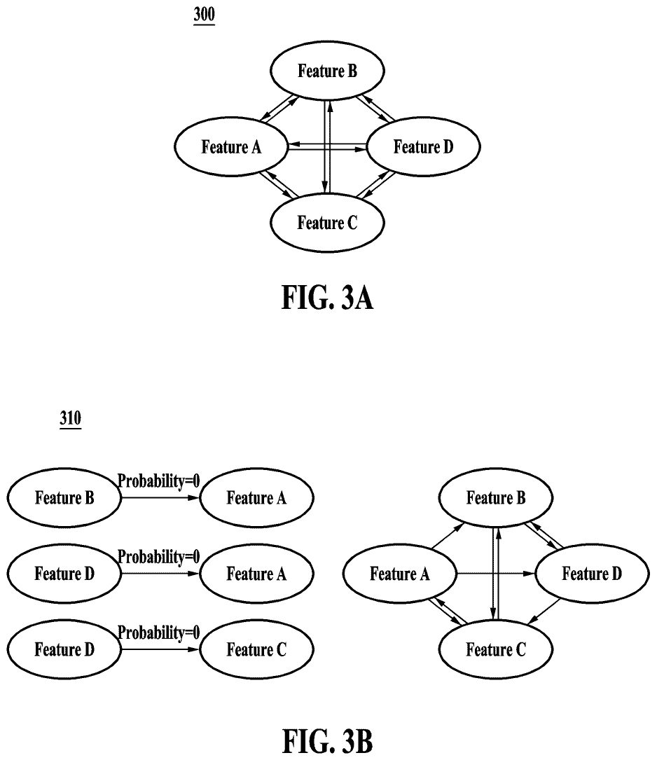

In an example, in step S120, the generation apparatus (e.g., electronic device 900 of FIG. 9) may generate a first graph based on at least one probability corresponding to at least one of relationships between the plurality of features. A method of generating the first graph is described in greater detail below with reference to FIGS. 3A and 3B.

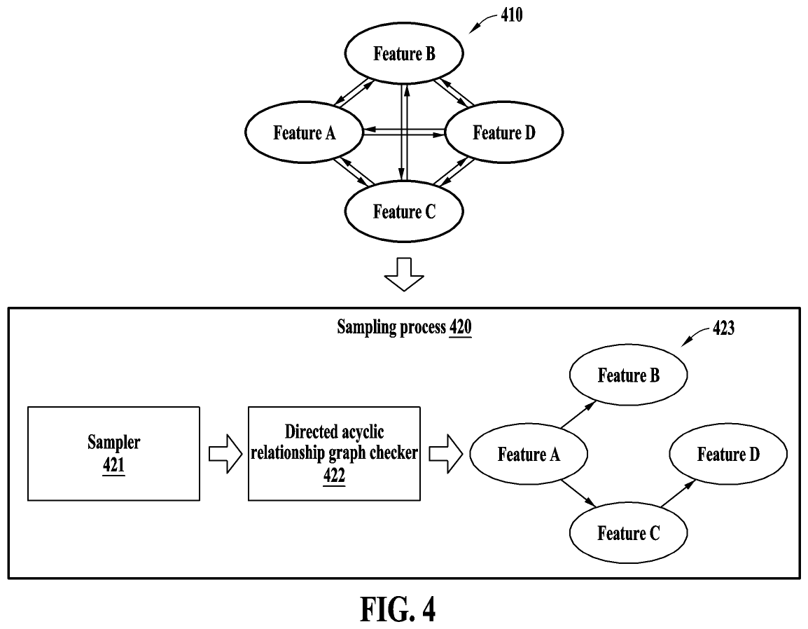

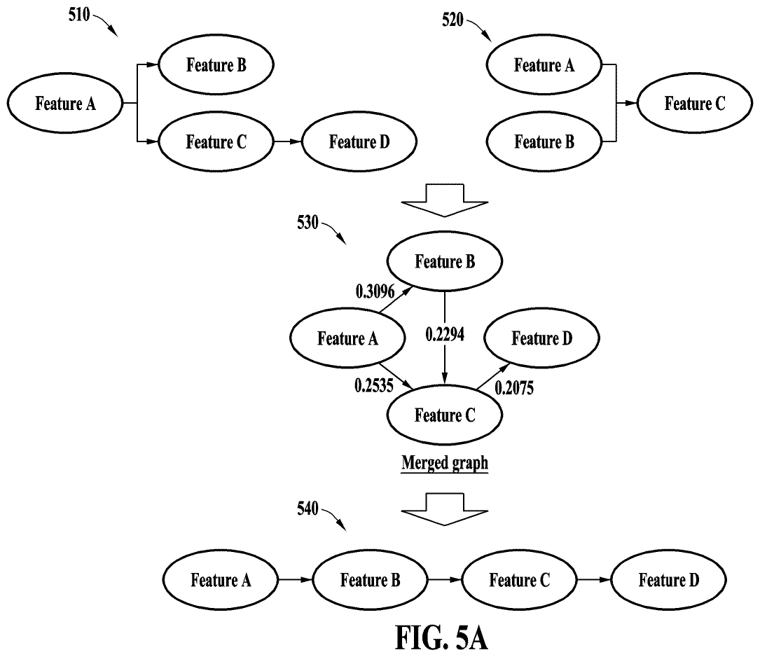

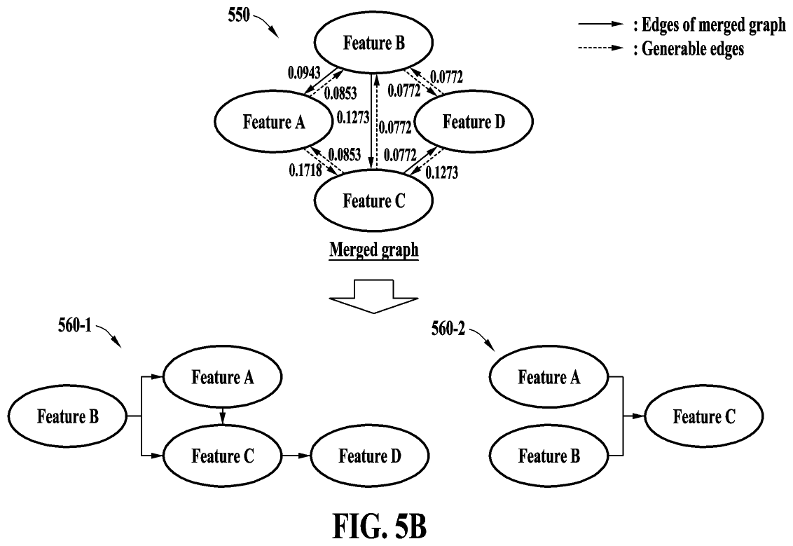

In an example, in step S130, the generation apparatus (e.g., electronic device 900 of FIG. 9) may generate, based on the first graph and the at least one probability, at least one second graph. The second graph may be a directed acyclic graph, or DAG. A method of generating the second graph is described in greater detail below with reference to FIG. 4 and FIGS. 5A and 5B.

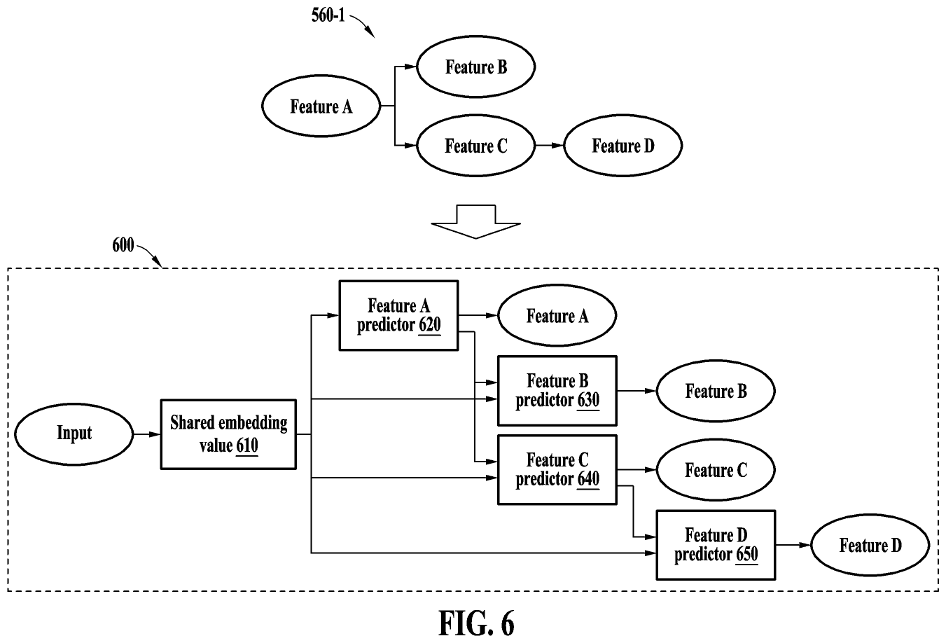

In an example, in step S140, the generation apparatus (e.g., electronic device 900 of FIG. 9) may generate at least one first multi-feature prediction model based on the at least one second graph. A method of generating the first multi-feature prediction model is described in greater detail below with reference to FIG. 6.

In an example, in step S150, the generation apparatus (e.g., electronic device 900 of FIG. 9) may train the at least one first multi-feature prediction model. In an example, the training of the first multi-feature prediction model may be performed based on a predetermined dataset. The predetermined dataset may refer to a set of data that is collected and processed in advance to train the model. The predetermined dataset may include input data and ground truth (e.g., labels) corresponding to an input in the input data and may be used for training and evaluating the model. For example, the evaluating of the model may include deriving performance metrics for the first multi-feature prediction model. For example, the predetermined dataset may include data on atomic structures and physical properties (or physical features) in the field of materials, and may include data on clinical information and diagnostic results of patients in the field of healthcare.

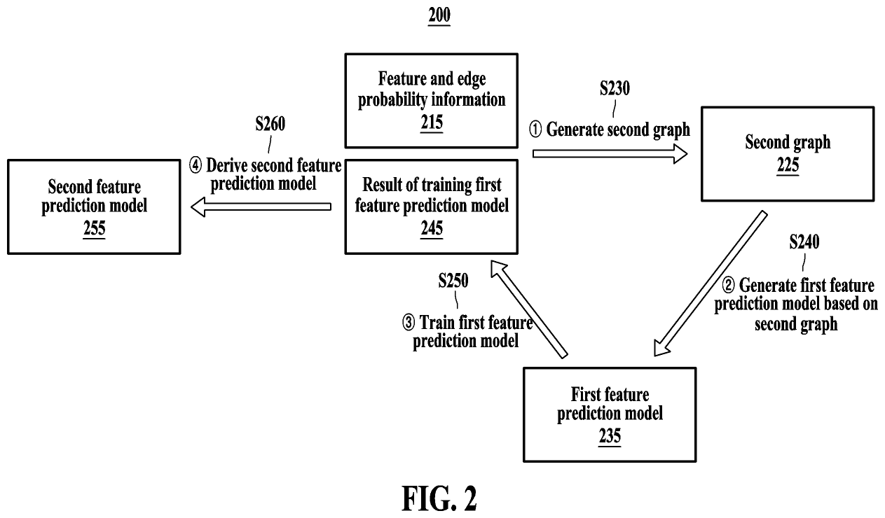

The generation apparatus may return to step S130 after performing the training (or learning). An iterative process of the generation apparatus is described in greater detail with reference to FIG. 2.

In an example, in step S160, the generation apparatus (e.g., electronic device 900 of FIG. 9) may derive a second multi-feature prediction model from the first multi-feature prediction model based on at least one performance metric acquired through the training performed at step S150. In an example, the performance metric may be a value for evaluating the performance in prediction by the first multi-feature prediction model. For example, the performance metric may include accuracy, precision, recall rate, and F1-score. In an example, the generation apparatus may derive, as the second multi-feature prediction model, a first multi-feature prediction model having a highest performance metric among first multi-feature prediction models. That is, the generation apparatus may derive, as the second multi-feature prediction model, a first multi-feature prediction model having a maximum performance metric.

The generation apparatus may generate a model that reflects a relationship between a plurality of features. The generation apparatus may thus improve the prediction performance for each feature by effectively utilizing complementary information between the plurality of features. The generation apparatus may also save additional computation and memory costs that may be required to reflect the relationships between the features when predicting each feature separately.

FIG. 2 illustrates an example method of a relationship graph-based multi-feature prediction model generation according to one or more embodiments.

What has been described above with reference to FIG. 1 may equally apply to what is to be described with reference to FIG. 2 and will not be repeated.

Referring to FIG. 2, in a non-limiting example, in method 200, a generation apparatus (e.g., electronic device 900 of FIG. 9) may iteratively perform, in each of a plurality of rounds, step S230 of generating a second graph, step S240 of generating a first multi-feature prediction model 235, and step S250 of training the first multi-feature prediction model 235.

In an example, in step S230, the generation apparatus (e.g., electronic device 900 of FIG. 9) may generate a second graph based on probabilities 215 corresponding to a plurality of features and edges in a current round. The generation apparatus may also generate a second graph 225 based on a training result 245. In an example, the training result 245 may include information associated with the first multi-feature prediction model 235. The information associated with the first multi-feature prediction model 235 may include second graph information used to generate the first multi-feature prediction model 235, performance metric information, model weight information (or parameter information), and the like. The training result 245 may be accumulated as the round is iterated. The generation apparatus may generate the second graph 225 based on the second graph information included in the accumulated training result.

In an example, in step S240, the generation apparatus may generate the first multi-feature prediction model 235. The generation apparatus may generate the first multi-feature prediction model 235 based on a training result acquired in a previous round of the current round. The generation apparatus may generate the first multi-feature prediction model 235 based on weight information (or parameter information) of the first multi-feature prediction model 235 in the training result acquired in the previous round. The generation apparatus may generate the first multi-feature prediction model 235 using the weight information (or parameter information) of the first multi-feature prediction model 235 as-is, in the training result acquired in the previous round. In this way, the generation apparatus may not need to separately generate weights (or parameters) in the process of training the first multi-feature prediction model 235, thereby reducing the training cost.

In an example, in step S250, the generation apparatus (e.g., electronic device 900 of FIG. 9) may train the first multi-feature prediction model 235. For example, when a value of a performance metric included in the training result 245 acquired by training the first multi-feature prediction model 235 in the round is less than or equal to a predetermined threshold value, the generation apparatus may not use, in a subsequent round, the second graph information used to generate the first multi-feature prediction model 235 in that round. Therefore, as the rounds develop, the generation apparatus may generate a new second graph 235 based on a second graph of a multi-feature prediction model that produces a higher level (or value) of performance metrics in a current round.

In an example, in step S260, the generation apparatus (e.g., electronic device 900 of FIG. 9) may derive a second multi-feature prediction model 255. The generation apparatus may iteratively perform steps S230, S240, and S250 in the plurality of rounds to finally derive at least one first multi-feature prediction model 235. In this case, when there is only one finally derived first multi-feature prediction model 235, that first multi-feature prediction model 235 may be the second multi-feature prediction model 255. When there are two or more finally derived first multi-feature prediction models 235, a model having the highest performance metric among the derived first multi-feature prediction models 235 may be derived as the second multi-feature prediction model 255.

FIGS. 3A and 3B illustrate example methods of generating a first graph according to one or more embodiments.

What has been described above with reference to FIGS. 1 and 2 may equally apply to what is to be described with reference to FIG. 3 and will not be repeated.

Referring to FIGS. 3A and 3B, in non-limiting examples, first graphs 300 and 310 are illustrated and these first graphs may include nodes corresponding to a plurality of features and edges corresponding to relationships between the nodes. The edges of the first graphs 300 and 310 may include directed edges. The first graph 300 and 310 may be a super-graph that incorporates all the edges represented based on all the nodes.

In an example, a generation apparatus (e.g., electronic device 900 of FIG. 9) may generate the first graph 300 and 310 based on at least one probability corresponding to the relationships between the plurality of features. The probability corresponding to a relationship between the plurality of features (or simply a “probability” hereinafter) may be a measure of relevance between the features. The probability may be a softmax value. The probability may be defined as a value to indicate the relevance of a relationship (or simply a “relevance value” hereinafter), which is normalized by a sum of relevance values corresponding respectively to all the relationships. The relevance value may be set directly by a user or may be acquired using a neural network module that analyzes correlations between the plurality of features. In an example, the neural network module may refer to a module that is performed using at least one processor in the generation apparatus or a module performed on a separate apparatus.

The relationships between the plurality of features may have different relevance values that are differentiated by a degree of relevance. The value to indicate relevance may be represented by a value of zero (0) in the absence of relevance between certain features and a value greater than zero (0) in the presence of relevance. However, other numerical systems may also be used to distinguish relevance for specific purposes or needs.

In an example, based on the probability corresponding to each relationship, the first graph 300 and 310 may include all the relationships between the plurality of features or at least some of the relationships. For example, FIGS. 3A and 3B illustrate graphs 300 and 310 which each include nodes corresponding to four features. Referring to FIG. 3A, a first graph 300 illustrates a case where the four features are all related to each other. The first graph 300 of FIG. 3A illustrates a case where probabilities corresponding to respective relationships are all greater than zero (0) and all possible edges between all the nodes are included. In contrast, referring to FIG. 3B, a first graph 310 illustrates a case where, in three relationships, features are not related to each other. The first graph 310 of FIG. 3B illustrates a case where a relationship from feature B to feature A, a relationship from feature D to feature A, and a relationship from feature D to feature C have probabilities of zero (0) and edges corresponding to the respective ones are not included.

FIG. 4 illustrates an example method of generating a second graph from a first graph according to one or more embodiments.

What has been described above with reference to FIGS. 1 through 3B may equally apply to what is to be described below with reference to FIG. 4 and will not be repeated.

In the following examples, the order of operations of processing elements (e.g., processor 910 of electronic device 900 of FIG. 9) may be changed, and the operations of at least two of the processing elements may be performed in parallel. While the processing elements are described separately for ease of description, each processing element may be understood as a logically distinct concept from other processors and/or processing elements. Each processing element may be implemented on one or more devices, depending on its design, and may communicate with each other in any suitable manner depending on the form in which it is implemented.

Referring to FIG. 4, in a non-limiting example, a generation apparatus (e.g., electronic device 900 of FIG. 9) may generate at least one second graph 423 based on a first graph 410 and at least one probability. The second graph 423 may be a directed acyclic graph, or DAG. For example, the generation apparatus may generate the second graph 423 through a sampling process 420 from the first graph 410. The sampling process 420 may be performed by, but is not necessarily limited to, a sampler processing element 421 and a directed acyclic relationship graph checker processing element 422.

The generation apparatus may also perform such a sampling process using a second graph generated in a previous round and an optimization algorithm. The sampling process of the generation apparatus, using the second graph generated in the previous round and the optimization algorithm, is described in greater detail below with reference to FIGS. 5A and 5B.

In an example, the sampler processing element 421 may perform sampling to generate a graph, by randomly selecting all possible nodes and edges from the first graph 410. The sampler processing element 421 may perform the sampling a predetermined number of times or a number of times determined based on the resources of the generation apparatus.

The directed acyclic relationship graph checker processing element 422 may check whether a graph generated by the sampler processing element 421 is a directed acyclic relationship graph. In an example, the directed acyclic graph may refer to a graph having directed edges with no cycles. A cycle in a graph may refer to a path that starts at a vertex, travels through several vertices, and then returns to the vertex from which it started. The directed acyclic graph may have a source node and a destination node based on the absence of such cycles. The directed acyclic graph may thus represent dependencies between nodes or represent a sequence of processing the nodes.

In an example, the generation apparatus may generate a first multi-feature prediction model in response to all the graphs generated by the sampler processing element 421 and derived through the directed acyclic relationship graph checker 422, and may adopt a model with the best training result as a second multi-feature prediction model.

FIG. 5A illustrates an example method of generating a second graph according to one or more embodiments. FIG. 5B illustrates an example method of generating a second graph according to one or more embodiments.

What has been described above with reference to FIGS. 1 through 4 may equally apply to what is to be described below with reference to FIGS. 5A and 5B and will not be repeated.

In an example a generation apparatus (e.g., electronic device 900 of FIG. 9) may perform an optimization algorithm to efficiently sample graphs to be generated by a first multi-feature prediction model. The optimization algorithm may include, for example, a genetic algorithm, reinforcement learning, Bayesian optimization, and the like.

In an example, the generation apparatus may perform the sampling based on merging of second graphs. According to an example embodiment, such merging-based sampling may be performed by the sampler processing element 421 in the generation apparatus. In an example, the generation apparatus may extract one or more combinations between second graphs generated in a previous round. In response to each of the combinations, the generation apparatus may generate a merged graph that merges second graphs included in a corresponding combination. In an example, the merged graph may be represented by a union of nodes and a union of edges of each of the second graphs included in the combination.

Based on at least one probability, the generation apparatus may extract a third graph by deleting or retaining each of all the edges included in the merged graph. In this case, the at least one probability may be a value acquired by normalizing a relevance value for a corresponding edge in the merged graph by a sum of relevance values corresponding respectively to all the edges in the merged graph. The generation apparatus may delete or retain edges such that only one edge exists between any two nodes in the third graph. The generation apparatus may also delete or retain edges from the merged graph differentially by reflecting a probability corresponding to each edge in the merged graph.

Referring to FIG. 5A, in a non-limiting example, a generation apparatus (e.g., electronic device 900 of FIG. 9) may extract two graphs 510 and 520 from among second graphs generated in a previous round. The generation apparatus may combine the extracted two graphs 510 and 520 to generate a merged graph 530. In an example, the merged graph 530 may include a node of {feature A, feature B, feature C, feature D} that is a union of features {feature A, feature B, feature C, and feature D} included in the graph 510 and features {feature A, feature B, and feature C} included in the graph 520. The merged graph 530 may also include an edge of {feature A→feature B, feature B→feature C, feature C→feature D, feature A→feature C} that is a union of edges {feature A→feature B, feature B→feature C, and feature C→feature D} included in the graph 510 and edges {feature A→feature C, and feature B→feature C} included in the graph 520. The merged graph 530 may include edges of feature A→feature B and feature A→feature C, for feature A, and the edges may have probabilities of 0.3096 and 0.2535, respectively. In this case, based on the probabilities, the generation apparatus may differentially retain the edge of feature A→feature B, which has a higher probability, and delete the edge of feature A→feature C. The generation apparatus may accordingly extract a third graph 540.

In an example, the generation apparatus may perform sampling based on a transformation of a second graph. The sampling may be performed by the sampler processing element 421 in the generation apparatus. In an example, the generation apparatus may iteratively extract one second graph among one or more second graphs. The generation apparatus may transform the one of the second graphs to generate at least one third graph. Referring to FIG. 5B, in a non-limiting example, a generation apparatus (e.g., electronic device 900 of FIG. 9) may extract one second graph 550 from among second graphs generated in a previous round. The second graph 550 shown in FIG. 5B may be a graph including nodes of {feature A, feature B, feature C, and feature D} and edges of {feature A→feature B, feature B→feature C, and feature C→feature D}. Here, edges indicated by dashed lines may indicate the number of all cases that may be generated by insertion or inversion of edges.

The third graph may be a graph acquired by adding (or inserting) at least one edge to the one second graph, deleting at least one edge included in the one second graph, and inversing at least one edge included in the one second graph, based on at least one probability. The at least one probability may be a value acquired by normalizing a relevance value of a corresponding edge in a merged graph by a sum of relevance values of all edges in the merged graph.

For example, FIG. 5B illustrates an example graph transformation process. The one second graph 550 may be transformed into a graph 560-1. In this example, edges of feature B→feature A, feature B→feature C, and feature C→feature D included in the second graph 550 may be retained. At the same time, an edge of feature A→feature C may be generated based on the fact that a probability corresponding to the edge of feature C→feature A is 0.1718, which is higher than other edges. The one second graph 550 may also be transformed into a graph 560-2. In this transformation process, an edge of feature C→feature D that has a relatively low probability, which is 0.0772, may be deleted, and an edge of feature B→feature A may also be deleted based on relatively low probability (0.0943), from the second graph 550.

The generation apparatus may extract a second graph from third graphs based on whether each of the third graphs corresponds to a directed acyclic graph. The directed acyclic relationship graph checker processing element 422 may check whether a third graph is the directed acyclic relationship graph. The generation apparatus may configure and train a first multi-feature prediction model based on the second graph extracted via the directed acyclic relationship graph checker processing element 422.

In an example, the generation apparatus may perform the sampling based on a reinforcement learning-based sampling process. The generation apparatus may acquire an edge vector by performing an action of an agent corresponding to each of edges of a first graph in a corresponding round, based on at least one probability. For example, the action may include deleting, generating, or inversing an edge.

In an example, the generation apparatus may also use a sampling technique that selects and processes an action stochastically (or simply a “sampling technique” hereinafter). The sampling technique may include, for example, a Gumbel-softmax method. In an example, the sampling technique may receive, as an input, a probability corresponding to each of the edges of the first graph and perform the action of the agent based on the input probability. According to an example embodiment, the sampling technique may be performed by the sampler processing element 421 in the generation apparatus.

In an example, the edge vector may include a vector having a dimension of the number of edges. The edge vector may include values of 0 and 1. The value of 0 in the edge vector may indicate the absence of a corresponding edge, and the value of 1 may indicate the presence of a corresponding edge. The edge vector may be generated based on at least one probability.

The generation apparatus may determine whether a graph based on the edge vector corresponds to the directed acyclic graph. The determination of whether the graph is the directed acyclic graph may be performed by the directed acyclic graph checker processing element 422 in the generation apparatus. When the graph based on the edge vector is not the directed acyclic graph, the generation apparatus may perform the action of the agent using the sampler processing element 421 to acquire the edge vector once again. When the graph based on the edge vector is the directed acyclic graph, the generation apparatus may extract the graph based on the edge vector as a second graph.

The agent may have, as a reward, a value based on a performance metric acquired through the training in a current round. In an example, the reward may be set to be based on a performance metric acquired through the training of a first multi-feature prediction model generated based on a second graph in a current round. For example, the reward may be a performance metric acquired through the training in a current round, or a performance metric increment value derived by a comparison between the performance metric acquired in the current round and a performance metric value acquired in a previous round preceding the current round. As rounds develop, the agent may be updated to maximize the reward.

Accordingly, the generation apparatus may effectively derive relationships without having to check all of the second graphs that may be extracted from the first graph, thereby minimizing the increase in time and computation costs.

FIG. 6 illustrates an example method of generating a multi-feature prediction model according to one or more embodiments.

What has been described above with reference to FIGS. 1 through 5B may equally apply to what is to be described below with reference to FIG. 6 and will not be repeated.

In an example, a first multi-feature prediction model may be a model that outputs multiple features in response to one given input data. A mathematical representation of the first multi-feature prediction model may be as in Equation 1.

$$( {y}^{1} , {y}^{2} , ... , {y}^{m} ) = f ( x ; w ) \qquad Equation 1$$

In Equation 1, x may denote input data of a model. In addition, f(x;w) may denote a machine learning model with a learning parameter w. Next, (y¹, y², . . . , y^{m}) may denote m output values acquired by the model, which may be predicted values corresponding respectively to a plurality of features. For example, in the field of materials, x may be the three-dimensional coordinates of atoms, and (y¹, y², . . . , y^{m}) may be predicted values of respective properties (also “features” herein), such as, energy, HOMO, LUMO, spectrum peak, and the like.

In an example, the first multi-feature prediction model may be implemented as a multi-task learning model that may learn (or train) multiple tasks simultaneously. The multi-task learning model may refer to a machine learning method in which a model is designed to learn multiple tasks simultaneously. Although different tasks are performed in the multi-task learning model, each task may share common information by using a shared embedding value (e.g., shared embedding value 610) generated by transforming the input data via a shared embedding processing element.

Each task of the first multi-feature prediction model may be a task of predicting a feature value corresponding to each of a plurality of features. The task of predicting the feature value may be performed by a feature prediction processing element included in the first multi-feature prediction model. The first multi-feature prediction model may include a plurality of nodes, i.e., a plurality of feature prediction processing elements corresponding respectively to the plurality of features.

The generation apparatus may generate at least one first multi-feature prediction model based on at least one second graph. Referring to FIG. 6, in a non-limiting example, a generation apparatus (e.g., electronic device 900 of FIG. 9) may generate a first multi-feature prediction model 600 in a cascade structure based on a second graph. By using the second graph, which is a directed acyclic graph, the generation apparatus may ensure that no cycles occur between feature prediction modules. This may allow a prediction result from another feature prediction to be used sequentially to predict a specific feature, and avoid the reverse in prediction order due to interdependency. For example, referring to FIG. 6, the generation apparatus may generate the first multi-trait prediction model 600 based on a structure of a second graph 560-1, which is the directed acyclic graph.

As the first multi-feature prediction model 600 is generated based on the second graph 560-1, an input value to each of the feature prediction modules may be an output value of a feature prediction module corresponding to a parent node of a node corresponding to a corresponding feature prediction processing element. Thus, in FIG. 6, a feature B predictor 630 may receive an output value of a feature A predictor 620 as an input. Similarly, a feature C predictor 640 may receive the output value of the feature A predictor 620 as an input, and a feature D predictor 650 may receive an output value of the feature C predictor 640 as an input. Each feature prediction module may be designed or configured to better reflect a relationship between features by receiving, as an input, an output value of a feature prediction module to which it is related, rather than relying solely on the shared embedding value 610. In an example, the output value of the feature prediction module corresponding to the parent node may include an output value of the last feature vector among feature vectors included in the feature prediction module.

The generation apparatus may not need to predict each feature separately, and a model may thus be designed such that the computation and memory costs required for feature prediction do not increase linearly with the number of features to be predicted. The generation apparatus may also achieve high prediction performance by reflecting information indicating interrelationships between multiple features that are useful for multi-feature prediction.

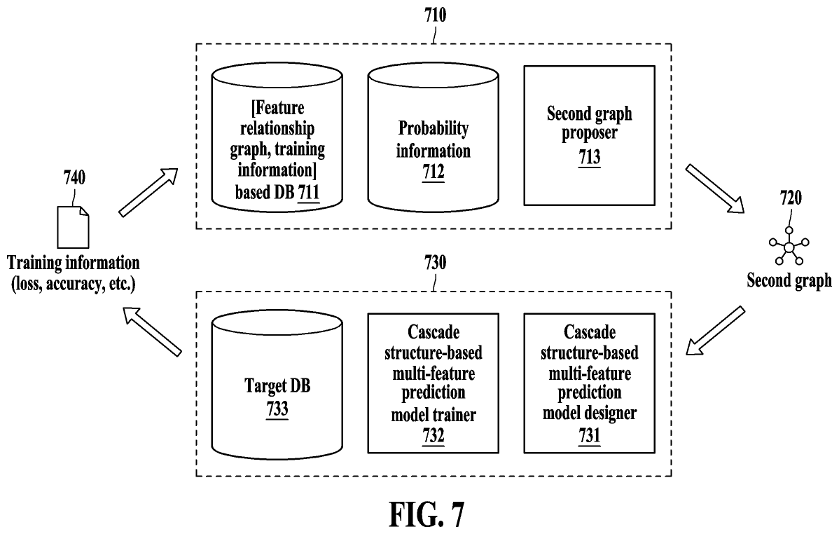

FIG. 7 illustrates an example relationship graph-based multi-feature prediction model generation apparatus according to one or more embodiments.

What has been described above with reference to FIGS. 1 through 6 may equally apply to what is to be described below with reference to FIG. 7 and will not be repeated.

Referring to FIG. 7, in a non-limiting example, a generation apparatus (e.g., electronic device 900 of FIG. 9) may include a subsystem 710 and a subsystem 730. The subsystem 710 may include a database (DB) 711 including second graphs and training results, a DB 712 including relevance information corresponding to edges, and a second graph proposer 713. The subsystem 710 may perform an operation of generating a first graph and an operation of generating at least one second graph, based on data stored in the DB 711 and the DB 712.

In an example, the DB 711 may accumulate second graphs generated in each round and training results acquired by training a first multi-feature prediction model acquired from the subsystem 730. The second graph proposer 713 may search and output the second graphs based on the data accumulated in the DB 711. The second graph proposer 713, which is based on machine learning, may search for an optimal second graph using an optimization algorithm, such as, for example, a random search, genetic algorithm, reinforcement learning, and Bayesian optimization.

In an example, the subsystem 730 may receive a second graph generated by the subsystem 710 as an input to configure and train a cascade first multi-feature prediction model. The subsystem 730 may include a designer 731 that configures a cascade structure-based multi-feature prediction model by analyzing the second graph received from the subsystem 710. The subsystem 730 may also include a DB 733 in which a target dataset, which is a baseline for training a model, is stored. The target dataset may include, for example, atomic structure and multi-feature data, in the field of materials. The subsystem 730 may also include a trainer 732 configured to train the first multi-feature prediction model using the DB 733. A training result acquired after the training is complete may be transferred to the subsystem 710.

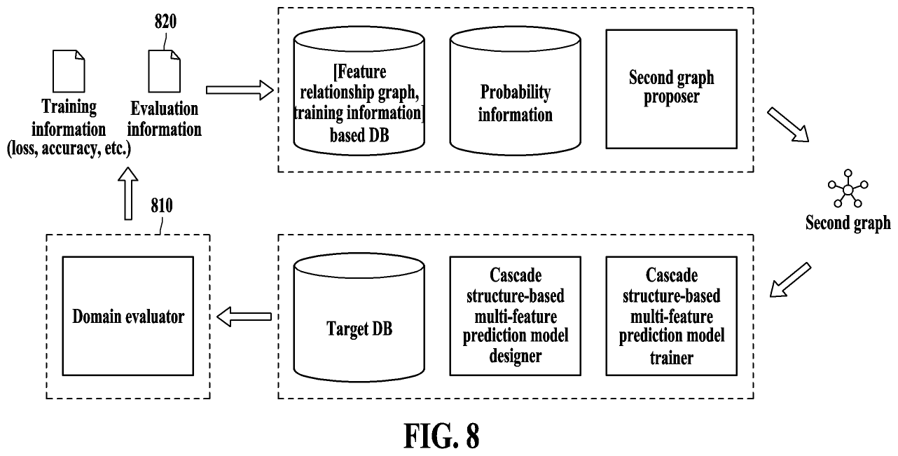

FIG. 8 illustrates an example method of domain evaluation according to one or more embodiments.

What has been described above with reference to FIGS. 1 through 7 may equally apply to what is to be described below with reference to FIG. 8 and will not be repeated.

Referring to FIG. 8, in a non-limiting example, a generation apparatus (e.g., electronic device 900 of FIG. 9) may derive a performance value of a first multi-feature prediction model using a predetermined evaluation method associated with a field in which at least one of a plurality of features is used. A user of the generation apparatus may evaluate the first multi-feature prediction model in other ways according to the user's desired application or goal. The generation apparatus may search for second graphs in a subsequent round using evaluation information 820 acquired through additional evaluation using the trained first multi-feature prediction model, in addition to a training result of the first multi-feature prediction model.

In an example, an evaluation method may be performed by a domain evaluator 810. The domain evaluator 810 may be employed by a user to suit their application based on at least some of a plurality of features predicted by the first multi-feature prediction model. For example, the user may design the domain evaluator 810 for this application. That is, it may be assumed that the primary purpose of developing a multi-feature prediction model for an expert in a particular field is to simulate molecular dynamics using the trained model. In this case, if there is feature information about energy and forces to be used as components of the dynamics simulation in a target DB used for training, the user may design a domain evaluator based on that feature information. In this way, the generation apparatus may serve to supply the materials required for the molecular dynamics simulation.

FIG. 9 illustrates an example electronic apparatus with relationship graph-based multi-feature prediction model generation according to one or more embodiments.

What has been described above with reference to FIGS. 1 through 8 may equally apply to what is to be described below with reference to FIG. 9 and will not be repeated.

Referring to FIG. 9, in a non-limiting example, an electronic device 900 may include a processor 910 and a memory 930. The processor 910 and memory 930 may communicate with each other and exchange data via a bus 905. The bus 905 may be configured as an electrical circuit and may include a data bus, an address bus, a control bus, and the like.

The processor 910 may receive a plurality of features as an input. The processor 910 may generate a first graph based on at least one probability corresponding to relationships between the plurality of features. The processor 910 may iteratively perform, in each of a plurality of rounds, operations including generating at least one second graph based on the first graph. Based on the at least one second graph, the processor 910 may generate at least one first multi-feature prediction model. The processor 910 may train the at least one first multi-feature prediction model. The processor 910 may derive a second multi-feature prediction model from the at least one first multi-feature prediction model based on a performance metric acquired through the training.

The memory 930 may include computer-readable instructions. The processor 910 may be configured to execute computer-readable instructions, such as those stored in the memory 930, and through execution of the computer-readable instructions, the processor 910 is configured to perform one or more, or any combination, of the operations and/or methods described herein. The memory 930 may include a volatile memory or a non-volatile memory. The memory 930 may include a mass storage medium, such as, a hard disk, to store various data.

Further, the processor 910 may perform at least one of the methods described above with reference to FIGS. 1 through 8 or an algorithm corresponding to the at least one method. The processor 910 may be a hardware-implemented data processing device having a physically structured circuit for executing desired operations. The desired operations may include, for example, code or instructions included in a program. The processor 910 may include, for example, a central processing unit (CPU), a graphics processing unit (GPU), or a neural network processing unit (NPU). The hardware-implemented generation apparatus 900 may include a microprocessor, a CPU, a processor core, a multi-core processor, a multiprocessor, an application-specific integrated circuit (ASIC), or a field-programmable gate array (FPGA). The processor 910 may include one or more processors and may be arranged to implement or may include one or more processing elements which may be configured to perform the various process element functions as described above.

The processor 910 may be configured to execute programs or applications to configure the processor 910 to control the electronic apparatus 900 to perform one or more or all operations and/or methods involving image processing, and may include any one or a combination of two or more of, for example, a central processing unit (CPU), a graphic processing unit (GPU), a neural processing unit (NPU) and tensor processing units (TPUs), but is not limited to the above-described examples.

The electronic device 900 may be implemented as various types of devices, including, but not limited to, a personal computer (PC), a server device, a mobile device, an embedded device, and the like, and may include, as more specific examples, a smartphone, a tablet device, an augmented reality (AR) device, an Internet of things (IoT) device, and/or a medical device that perform speech recognition, image recognition, image classification, and the like using neural networks. The electronic device 900 900 may also be a dedicated hardware accelerator provided in the above-described devices, or a hardware accelerator such as an NPU, a tensor processing unit (TPU), a memory operator, and/or a neural engine, which is a dedicated module for driving a neural network.

The processors, processing elements, memories, databases, electronic devices, neural networks, first multi-feature prediction model 235, second feature prediction model 255, subsystem 710 and 730, databases 711, 712, and 733, trainer 732, second graph proposer 713, model designer 731, model trainer 732, domain evaluator 810, electronic device 900, processor 910, and memory 930 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a first graph based on at least one probability corresponding to relationships between a plurality of features;
iteratively performing, in a plurality of rounds, operations, the operations comprising:
generating at least one second graph based on the first graph, wherein the second graph is a directed acyclic graph;
generating at least one first multi-feature prediction model based on the at least one second graph; and
training the at least one first multi-feature prediction model; and
deriving a second multi-feature prediction model from the at least one first multi-feature prediction model,
wherein the first graph comprises nodes corresponding to the plurality of features and at least one edge corresponding to at least a portion of the relationships.

2. The method of claim 1, wherein the generating of the second graph comprises:
deriving, based on a result of the training, one or more second graphs generated in at least one previous round preceding a current round; and
generating the second graph based on the derived second graphs.

3. The method of claim 2, wherein the generating of the second graph comprises:
extracting one or more combinations between the one or more second graphs generated in the previous round;
for each of the combinations, generating a merged graph that merges second graphs comprised in each combination;
generating a third graph by randomly deleting or retaining each of all edges comprised in the merged graph, based on the at least one probability; and
extracting the second graph from the third graph, based on whether the third graph is the directed acyclic graph.

4. The method of claim 2, wherein the generating of the second graph comprises:
iteratively extracting one of the one or more second graphs generated in the previous round;
generating one or more third graphs by transforming the one of the second graphs; and
extracting the second graph from the third graphs, based on whether the third graph is the directed acyclic graph.

5. The method of claim 4, wherein the third graph comprises one or more of:
a graph acquired by adding at least one edge to the one of the second graphs, a graph acquired by deleting at least one edge included in the one of the second graphs, and a graph acquired by inversing at least one edge included in the one of the second graphs, based on the at least one probability.

6. The method of claim 1, wherein the generating of the second graph comprises:
in a current round, acquiring an edge vector by performing an action of an agent corresponding to edges of the first graph based on the at least one probability; and
extracting the second graph, based on whether a graph based on the edge vector corresponds to the directed acyclic graph,
wherein the edge vector comprises:
a vector having a first number of dimensions equal to a second number of the edges comprised in the first graph.

7. The method of claim 6, wherein the agent has, as a reward, a value based on a performance metric acquired through the training in the current round.

8. The method of claim 1, wherein the first multi-feature prediction model comprises:
a plurality of feature prediction processing elements corresponding respectively to the nodes, and
wherein the generating of the first multi-feature prediction model comprises:
generating the first multi-feature prediction model such that an input value of each of the plurality of feature prediction processing elements is determined based on a structure of the second graph.

9. The method of claim 8, wherein the input value of each of the plurality of feature prediction processing elements is an output value of a feature prediction processing element corresponding to a parent node of a node corresponding to a corresponding feature prediction processing element.

10. The method of claim 9, wherein the output value of the feature prediction processing element corresponding to the parent node is an output value of a last feature vector among feature vectors comprised in the feature prediction processing element.

11. The method of claim 1, wherein the training of the first multi-feature prediction model comprises:
training the first multi-feature prediction model based on a predetermined dataset.

12. The method of claim 1, further comprising:
deriving a performance value of the first multi-feature prediction model, using a predetermined evaluation method associated with a field in which at least one of the plurality of features is used.

13. The method of claim 1, wherein the training the at least one first multi-feature prediction model comprises:
performing an evaluation of the at least one first multi-feature prediction model for each round, and
wherein the deriving a second multi-feature prediction model comprises:
selecting a first multi-feature prediction model from the at least one first multi-feature prediction model with a highest evaluation as the second multi-feature prediction model.

14. An electronic apparatus, the apparatus comprising:
processors configured to execute instructions; and
a memory storing the instructions, wherein execution of the instructions configures the processors to:
generate a first graph based on at least one probability corresponding to relationships between a plurality of features;
iteratively perform, in a plurality of rounds, operations, the operations comprising:
generating at least one second graph based on the first graph, wherein the second graph is a directed acyclic graph;
generating at least one first multi-feature prediction model based on the at least one second graph; and
training the at least one first multi-feature prediction model; and
derive a second multi-feature prediction model from the at least one first multi-feature prediction model,
wherein the first graph comprises nodes corresponding to the plurality of features and at least one edge corresponding to at least a portion of the relationships.

15. The apparatus of claim 14, wherein the generating of the second graph comprises:
deriving, based on a result of the training, one or more second graphs generated in at least one previous round preceding a current round; and
generating the second graph based on the derived second graphs.

16. The apparatus of claim 15, wherein the generating of the second graph comprises:
extracting one or more combinations between the one or more second graphs generated in the previous round;
for each of the combinations, generating a merged graph that merges the second graphs comprised in each combination;
generating a third graph by randomly deleting or retaining each of all edges comprised in the merged graph, based on the at least one probability; and
extracting the second graph from the third graph, based on whether the second graph is the directed acyclic graph.

17. The apparatus of claim 15, wherein the generating of the second graph comprises:
iteratively extracting one of the one or more second graphs generated in the previous round;
generating one or more third graphs by transforming the one of the second graphs; and
extracting the second graph from the third graphs, based on whether the third graph is the directed acyclic graph.

18. The apparatus of claim 15, wherein the generating of the second graph comprises:
in a current round, acquiring an edge vector by performing an action of an agent corresponding to edges of the first graph based on the at least one probability; and
extracting the second graph, based on whether a graph based on the edge vector corresponds to the directed acyclic graph,
wherein the edge vector comprises a vector having a first number of dimensions equal to a second number of the edges comprised in the first graph.

19. The apparatus of claim 15, wherein the first multi-feature prediction model comprises:
a plurality of feature prediction processing elements corresponding respectively to the nodes,
wherein the generating of the first multi-feature prediction model comprises:
generating the first multi-feature prediction model such that an input value of each of the plurality of feature prediction processing elements is determined based on a structure of the second graph.

20. The apparatus of claim 19, wherein the input value of each of the plurality of feature prediction processing elements is an output value of a feature prediction processing element corresponding to a parent node of a node corresponding to a corresponding feature prediction processing element.
